(19) United States
(12) Patent Application Publication
(10) Pub. No.: US 2015/0039908 A1
(43) Pub. Date: Feb. 5, 2015

(54) System and Method for Securing A Credential Vault On A Trusted Computing Base

(71) Applicant: Deutsche Telekom AG, Bonn (DE)

(72) Inventors: Garner Lee, San Jose, CA (US); Siddartha Pothapragada, Santa Clara, CA (US); Ming Yin, Berlin (DE)

(21) Appl. No.: 13/954,213

(22) Filed: Jul. 30, 2013

(51) Int. Cl. G06F 21/45; G06F 21/62; G06F 21/35

(52) U.S. Cl. CPC G06F 21/45; G06F 21/35; G06F 21/62
USPC 713/193; 726/9

(57) ABSTRACT

A method for utilizing a secure credential vault on a mobile computing device includes: prompting a user for and receiving from the user a credential vault password; prompting a user for and receiving a near-field communication (NFC) security token from a NFC-enabled device; verifying the credential vault password and the received NFC security token; and opening a secure session with the secure credential vault in response to successful verification.

### FIELD

The invention relates generally to credentials security, and specifically to using a physical device-based token, such as a token on a Near Field Communication (NFC)-enabled keychain, to enhance security of website credentials stored in a trusted computing base (TCB).

### BACKGROUND

Presenting credentials in the form of a username and password specific to a website or application is a common task a user must do when accessing a secure resource located either locally or on an internet website. Each website likely has a different set of credentials. Often, a password manager, or credential vault, is used to manage numerous passwords.

For example, in operation, when a user attempts to access a webpage requiring log-in information and types a username and a password into the corresponding prompts provided via a web browser, the web browser may present the user with an option to store the credentials in a credential vault associated with the web browser. Then, when the user returns to that webpage later on through the same Uniform Resource Locator (URL), a credential vault manager application can then access the credential vault to automatically fill the log-in prompts with the username and password previously stored in the credential vault for that URL.

Storing a user's credentials in a credential vault can be risky, as someone other than the user using the device on which the credentials are stored may be able to gain access to secure websites or applications using the user's stored credentials which are automatically filled in by the credential vault manager application. While conventional mobile phones and computers often have a type of lock screen that requires a password (e.g., a password string, a PIN, a gesture, or some kind of security token), such lock screens may not provide an adequate level of security, as they are relatively susceptible to circumvention (e.g., by looking for fingerprint patterns on a screen) or may not be activated in time to prevent an unauthorized user (e.g., due to a grace period before actual locking occurs).

The credential vault may utilize an encryption algorithm, for example symmetric encryption according to the Advanced Encryption Standard (AES), for storage and retrieval of usernames and passwords, and may further prompt a user for a credential vault password to permit access to the credential vault. Decryption of the stored usernames and passwords stored in the credential vault is performed only upon provision of the credential vault password. However, prompting the user for a credential vault password has similar vulnerabilities to a lock screen, as it may be possible to obtain the password through, for example, external recording device or by looking for fingerprint patterns.

### SUMMARY

In an embodiment, the present invention provides a method for utilizing a secure credential vault on a mobile computing device. The method includes: prompting, by the mobile computing device, a user for a credential vault password and receiving the credential vault password from the user; prompting, by the mobile computing device, a user for a near-field communication (NFC) security token and receiving the NFC security token from a NFC-enabled device; verifying, by the mobile computing device, the credential vault password and the received NFC security token; and opening, by the mobile computing device, a secure session with the secure credential vault in response to successful verification.

### BRIEF DESCRIPTION OF THE SEVERAL VIEWS OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 illustrates exemplary components of an exemplary computing device suitable for embodiments of the present invention;

FIG. 2 is a block diagram illustrating overall system architecture having two levels of authorization and encryption in an embodiment of the present invention;

FIG. 3 is a flow diagram illustrating a process for opening and closing a secure session with the credential vault;

FIG. 4 is a flow diagram illustrating a process for adding credentials to the credential vault;

FIG. 5 is a flow diagram illustrating a process for looking up and retrieving credentials from the credential vault;

FIG. 6 is a flow diagram illustrating a process for updating credentials in the credential vault; and

FIG. 7 is a flow diagram illustrating a process for deleting credentials in the credential vault.

### DETAILED DESCRIPTION

Embodiments of the present invention provide a credential vault for storing website account credentials (e.g., usernames and passwords), where the credential vault is protected by a password and additional protected by a second authentication token introduced using an NFC token, such as a physical NFC-enabled device (e.g., a keychain). The NFC-enabled device contains a security token separate from the credential vault password that protects the credential vault. This security token can be another password string, for example, a randomly generated string (the string is not typed in by the user, it is stored on the physical NFC-enabled device), or a non-random string chosen by the user.

This dual-level enhanced security involving credential vault password authentication and NFC token authentication may be enabled or disabled. When it is enabled, the user must present the physical NFC-enabled device when prompted by a credential vault manager application, in addition to entering the credential vault password, in order for the credential vault to allow access to the encrypted contents.

The credential vault is stored inside a TCB of the corresponding computing device. In embodiments of the present invention involving mobile phones, a very secure environment is available (e.g., a Subscriber Identity Module (SIM) card or other embedded secure element (SE)) for serving as a TCB. The secure element is a security-managed space that is typically used for storing carrier-related or device maker-related information, but can also be used to host user information in a credential vault as well. Storing account credentials inside the secure element of the mobile phone provides for an extra layer of protection for the stored credentials. For example, for applications and data loaded on a SIM card, the mobile network operator is able to control the security environment and can restrict where stored credentials can be transferred based on security context such as time and location, and is further able to remotely delete the credential vault if the mobile phone or security token is stolen (and connected to the network). It will be appreciated that even if the credential vault is deleted, the user does not lose access to the websites for which credentials are stored in the credential vault, as the user can always enter the required username and passwords manually (into a web browser or into the credential vault). The user can also clear entries from the credential vault similar to how the user can clear information stored in a web browser.

Advantages provided by embodiments of the present invention include, but are not limited to, the following:
Two-factor authentication secures credential vault storage by requiring a second input method different from a first credential input method used to protect the credential vault database. The lack of one or both security inputs is sufficient for the credential vault manager application to confidently reject decryption and access to the user's credentials for a particular website or application. The feature of two-factor authentication is capable of being enabled or disabled by user preference.
The credential vault is placed in a TCB such that additional security measures can be applied to further restrict access.
The owners/issuer of the TCB (i.e., the company issuing a SIM card upon which the TCB is stored) is prohibited from accessing the contents of the credential vault without appropriate authorization.
Secure transport of the credential vault data from one device to another device is possible, and advantageously without any other permanent network storage of the credential vault data.
The two-factor authentication remains easy to use for the user. The user presents the second input (e.g., a physical NFC-enabled keychain having a security token stored thereon) when prompted.

Before turning to the specific details regarding the operation and architecture of embodiments of the present invention, a general overview of an exemplary operating environment is provided below. It will be appreciated that the operating environment provided below is merely illustrative, and embodiments of the present invention are not limited thereto.

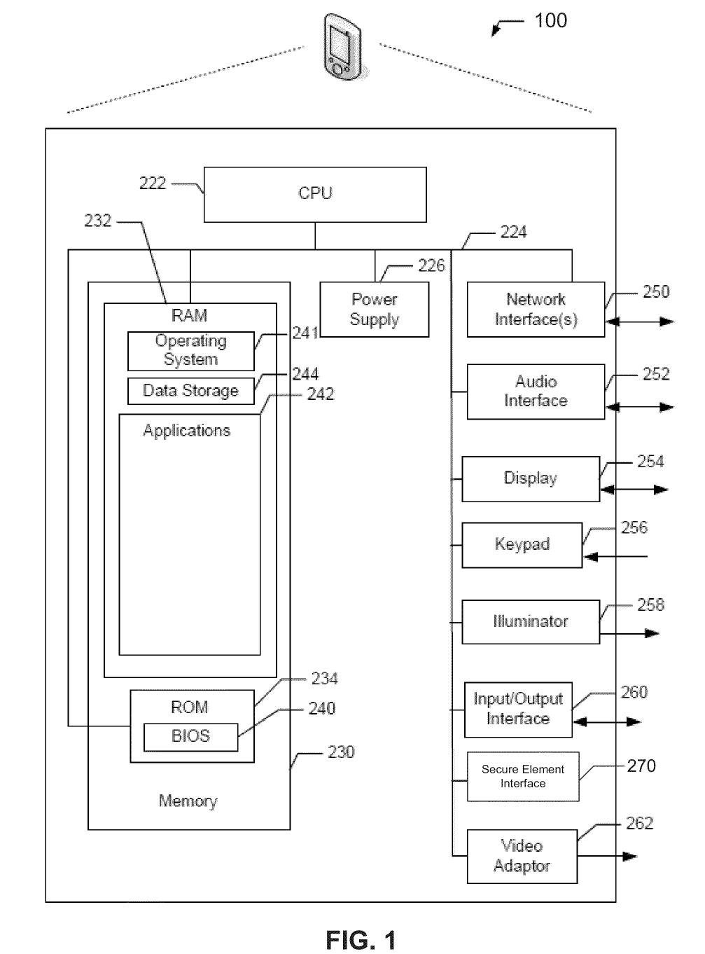

FIG. 1 depicts an exemplary device 100. Generally, the device 100 may be any mobile computing device capable of receiving data over a network (e.g., a wireless network and/or the Internet). Such devices include portable devices such as, cellular telephones, smart phones, radio frequency (RF) devices, infrared devices, Personal Digital Assistants (PDAs), handheld computers, laptop computers, wearable computers, tablet computers, integrated devices combining one or more of the preceding devices, or the like. It will be appreciated however, that the principles described herein may also be applied to other types of computing devices and are not limited to mobile or portable computing devices.

Device 100 may include many more or less components than those shown in FIG. 1. The components that are shown are merely illustrative, and are sufficient to implement an exemplary environment for practicing embodiments of the present invention.

Device 100 includes a processing unit (CPU) 222 in communication with a mass memory 230 via a bus 224. Device 100 also includes a power supply 226, one or more network interfaces 250, an audio interface 252, a display 254, a keypad 256, an illuminator 258, and an input/output interface 260. Power supply 226 provides power to device 100. A rechargeable or non-rechargeable battery may be used to provide power. The power may also be provided by an external power source, such as an AC adapter or a powered docking cradle that supplements and/or recharges a battery.

Device 100 can communicate with another computing device directly or indirectly via network interface 250. Network interface 250 includes circuitry for coupling device 100 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone to enable telecommunication with others and/or generate an audio acknowledgement for some action. Audio interface 252 can further be configured to play back music signals by converting digital audio data into voice signals.

Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand. In addition, device 200 may further include video adaptor 262, which is configured to provide video signals to an external display.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the device is powered. In addition, illuminator 258 may backlight these buttons in various patterns when particular actions are performed, such as dialing another device. Illuminator 258 may also cause light sources positioned within a transparent or translucent case of the device to illuminate in response to actions.

Device 100 also includes input/output interface 260 for communicating with external devices, such as a headset. Input/output interface 260 can utilize one or more communication technologies, such as USB and NFC technologies like infrared, Bluetooth™, or the like.

Device 100 further includes a secure element interface 270 for connecting to a secure element usable as a TCB, such as a SIM card or a Universal Integrated Circuit Card (UICC).

Different implementations of device 100 can range widely in terms of capabilities and features. In one example, device 100 is a web-enabled mobile device such as a PDA may have a touch sensitive screen, a stylus, and several lines of color LCD display in which both text and graphics may be displayed. In another example, device 100 is a multimedia-enabled mobile device such as laptop may include a multimedia application 245 such as a video player application, which is configured to render images, videos streams, audio signals, or the like through a multimedia interface such as a color LCD or LED screen or a microphone. In still another example, device 100 includes a browser application configured to receive and display graphics, text, multimedia, or the like, employing virtually any web-based language, including a wireless application protocol messages (WAP), or the like. For example, the browser application is enabled to employ Handheld Device Markup Language (HDML), Wireless Markup Language (WML), WMLScript, JavaScript, Standard Generalized Markup Language (SMGL), HyperText Markup Language (HTML), extensible Markup Language (XML), or the like, to display and send information.

In a preferred embodiment of the present invention, device 100 is an NFC-enabled smartphone, with a TCB physically local to the device such as a SIM card or a UICC. The SIM card or UICC has sufficient storage space to allow hosting of a credential vault and a card application (e.g., a “Cardlet”) that executes commands provided by a credential vault manager application running via a web browser or web browser platform on the device 100. Further, encryption libraries are available to the credential vault manager application and a baseband processor of the device 100.

The credential vault manager application is an application executed by the device 100 that manages the addition, lookup, and deletion of credential entries in the TCB. The entries are stored as key value pairs. A single value can map to one or more values—e.g., a website identification (URL) can have more than one account available to the same user and thus have multiple credentials-pairs mapped to that URL.

A physical NFC-enabled device, such as a NFC keychain, is provided with a security token stored thereon. The security token on the NFC keychain can be a password string. The NFC keychain is presented to an NFC reader (i.e., input/output interface 260) of the device 100 when prompted by the credential vault manager application. While it may be possible to copy an NFC keychain like a real physical key, the NFC keychain alone is not sufficient to provide access to and decrypt the credential vault. The user is also required to enter a credential vault password when prompted by the credential vault manager. The credential vault password may be a password string that is entered by the user into the device 100, or some other type of security token.

An exemplary basic credential vault record may take the following key-value map format (the word “key” as used in the context of “key-value map” does not refer to keys used for encryption):
[key: (url identifier)][value: (username, password)]

Thus, username and password credentials stored in the credential vault are encrypted and protected by two layers of security. Before access to the stored credentials is permitted, the user must provide a primary credential vault password, and additionally an NFC security password/token (by bringing the appropriate NFC-enabled physical device within proximity to the device 100 when prompted). It will be appreciated that the additional step of NFC security is a feature that may be enabled or disabled by the user.

Without the primary credential vault password or the NFC security password/token, the entries of the credential vault stored in the TCB are encrypted. To increase encryption strength, short usernames and passwords may be padded by random bits to a minimum length, or all passwords may be salted before storing them in the credential vault.

The lack of system level permissions to get access to the TCB also prevents access entirely to the secure element (in other words, applications of a mobile device generally do not have permission to access the TCB). Further, the secure element is also protected by security keys. A “Cardlet” (a type of card application) runs on the secure element inside the security environment, and carries out credentials management operations (add, lookup, modify, delete) for the credential vault, as well as retrieval of user credentials. For security, the NFC token password is not stored (to prevent possible decryption and theft of the NFC token password).

It will be appreciated that, for security reasons, the NFC token password and credentials passwords are not saved by the credential vault manager application or by the card application. While in some sense, the password is temporarily “stored” in the mobile phone software stack that acts an agent for the user to decrypt the contents of the credential vault, once the credential access session is over the software does not save the credentials passwords in an easy-to-access manner anywhere (in RAM or otherwise).

Provided that each entry stored in the credential vault is a database entry, it is possible to add a data synchronization tool to synchronize the credentials to another device. If a target device does not have the ability to utilize an NFC token (for example, a desktop web browser on a computing device without NFC capabilities), it is still possible to retrieve the contents. It will ask the user to input the NFC token password (assuming the user knows the NFC token password or can access it) along with the credential vault password.

It is preferred that each level of authorization uses a cryptographically strong password or passphrase.

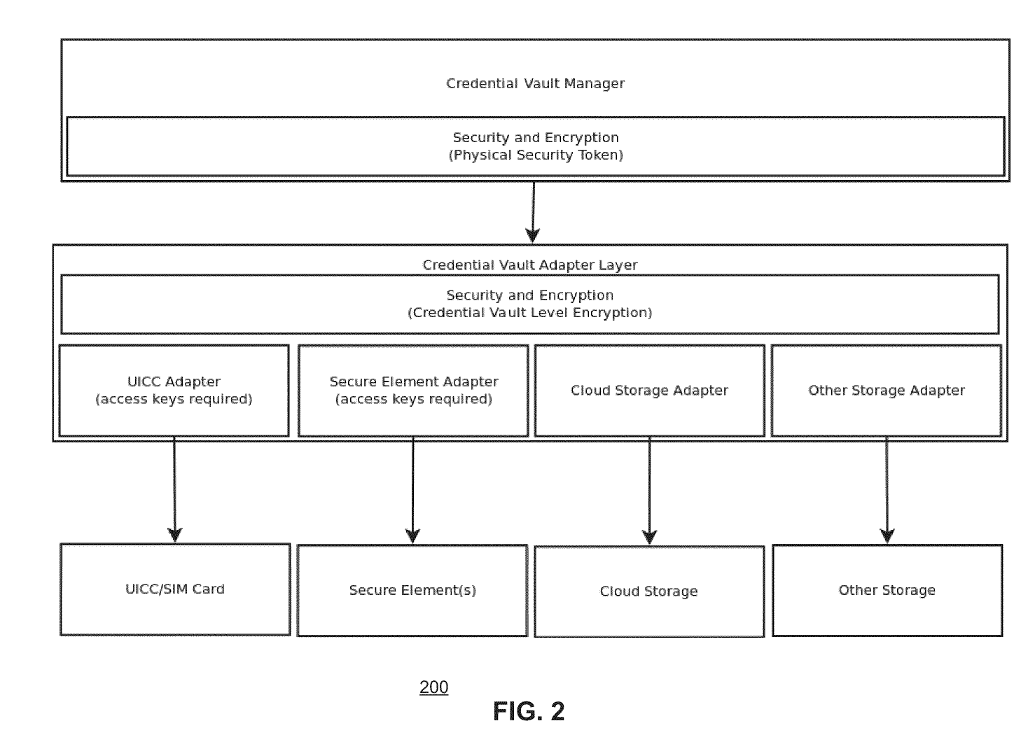

With further reference to the exemplary environment of FIG. 1, and turning more specifically to FIG. 2, a block diagram is depicted illustrating an overall system architecture having two levels of authorization and encryption in an embodiment of the present invention. The top level is a “Credential Vault Manager” which includes “Security and Encryption” for providing access control. The “Security and Encryption” for the “Credential Vault Manager” includes a “(Physical Security Token)”—e.g., a password stored on an NFC-enabled device.

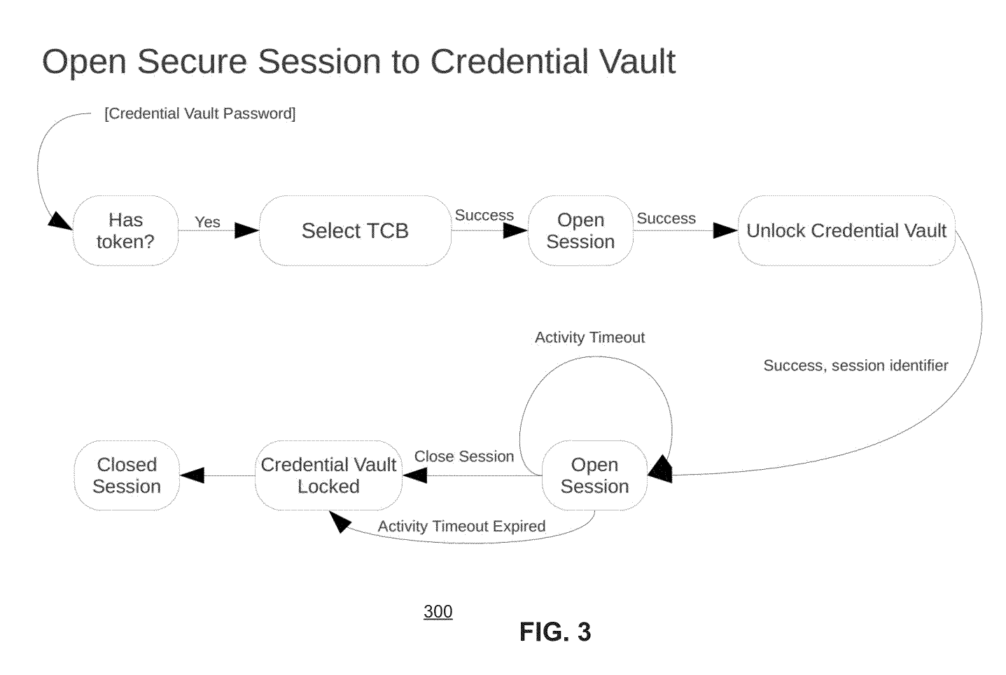

The “Credential Vault Manager” interacts with a “Credential Vault Adapter Layer” that also includes “Security and Encryption.” The “Security and Encryption” here refers to “(Credential Vault Level Encryption)” which protects the credentials stored in the credential vault. Commands sent from the “Credential Vault Manager” to the “Credential Vault Adapter Layer” include open, close, add, delete, update, and encryption functionality (as will be discussed below with reference to FIGS. 3-7). These commands adhere to a common protocol interface to the “Credential Vault Manager.” Different embodiments of the Credential Vault Adapter layer include one or more of a “UICC Adapter.” “Secure Element Adapter,” “Cloud Storage Adapter,” and “Other Storage Adapter” depending on how the credentials vault is implemented. If implemented in a SIM card or UICC, the Credential Vault Adapter Layer interacts utilizes the “UICC Adapter” to interact with the credentials vault using “access keys.” If implemented in another type of “Secure Element,” the Credential Vault Adapter Layer interacts utilizes the “Secure Element Adapter” to interact with the credentials vault using “access keys.” If the credentials vault is implemented in cloud storage, the Credential Vault Adapter Layer interacts utilizes the “Secure Element Adapter” to interact with the credentials vault. If the credentials vault is implemented in some other type of storage, the Credential Vault Adapter Layer interacts utilizes the “Other Storage Adapter” to interact with the credentials vault (for example, a Secure Digital (SD) storage card).

FIGS. 3-7 depict flowcharts illustrating exemplary operations performed by the credential vault application manager in combination with a card application (e.g., “Cardlet”) of the TCB.

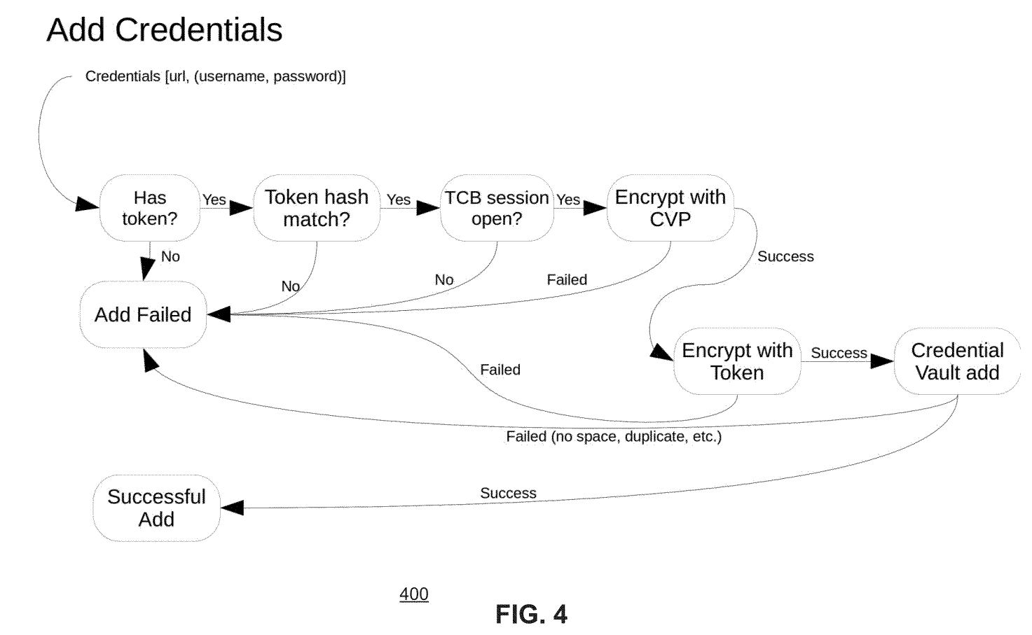

FIG. 3 depicts a flowchart illustrating the opening and closing of a secure session with the credential vault of the TCB. The user of the computing device provides a credential vault password to the credential vault manager application. The credential vault manager application further checks whether the user has the appropriate token, for example, by prompting the user to wave an appropriate NFC keychain over the computing device. Once the credential vault manager application verifies the credential vault password and that the NFC security token has been provided, the user has the option to select a TCB if there are multiple TCBs. (It will be appreciated this selection step need not occur if there are not multiple TCBs available to the credential vault manager application.) A session is then opened with the selected TCB, and the credential vault is “unlocked” and a session identifier is provided. An open session is thus established, through which the user will have access to a decrypted version of the encrypted information stored in the credential vault, as well as being able to create, modify, or delete such information. While the session is open, a time-out counter runs and upon expiration of the time-out counter, the credential vault is “locked” and the secure session is closed. Alternatively, the user may also manually choose to end the session and “lock” the credential vault. In an embodiment, the purpose of opening a session according to the process of FIG. 3 is to have both the NFC token and credential vault password stored in temporary memory (e.g., RAM) to enable the performance of other functions such as those depicted in FIGS. 4-7.

FIG. 4 depicts a flowchart illustrating a process for adding credentials to the credential vault. When a website or application presents a security challenge using usernames and passwords, a user enters the username and passwords in the corresponding fields. The user is then presented with an option to save the entered username and password in the credential vault, and if the user responds affirmatively, the credential application manager application and/or web browser or application prompts the user for the credential vault password and/or the NFC security token. In the embodiment depicted by FIG. 4, the user is only asked for the NFC security token, and then the credential vault manager application verifies the NFC security token by checking for a secure hash match (e.g., hashed using a one way algorithm such as SHA-2 or SHA-3) and determining whether a TCB session is open. Performing the hash match determination allows the system to check the NFC security token credentials without exposing a larger attack surface (for security reasons) and without requiring constant opening and closing of the credential vault (for performance reasons). If the user fails to provide the NFC security token, the NFC security token hash match fails, or if a TCB session is not open, the add operation fails. It will be appreciated that in certain embodiments, checking whether the user has the NFC security token and/or whether the token hash is a match is subsumed with the session open process depicted in FIG. 3.

In this exemplary embodiment, the credentials to be stored are then encrypted using the CVP and encrypted using the NFC token. For example, a symmetric encryption algorithm such as AES is used to convert the credentials data into something that is unreadable without the two passwords, the CVP and the NFC token (i.e., both are used as keys). Because it is symmetric, the same passwords can be used to recover the data in its original form. In an alternative embodiment, an asymmetric encryption scheme using public and private keys (such as RSA) is used to encrypt the credentials data.

After the URL of the website or application identifier, together with the username and password entered by the user, are encrypted, the encrypted credentials are stored in the credential vault in the TCB. If there is not enough storage in the TCB, or if the credentials entry is a duplicate, the add operation may fail, and otherwise, the add operation succeeds.

Alternatively, when there is no more storage space in the TCB, relatively older encrypted entries of the TCB may be securely transferred to cloud storage. Another alternative is to prompt the user to clear some entries of the credential vault (and reject add operations until storage space is available). Credentials can be compressed before encryption and decompressed upon retrieval to enhance the amount of free space in more limited storage environments.

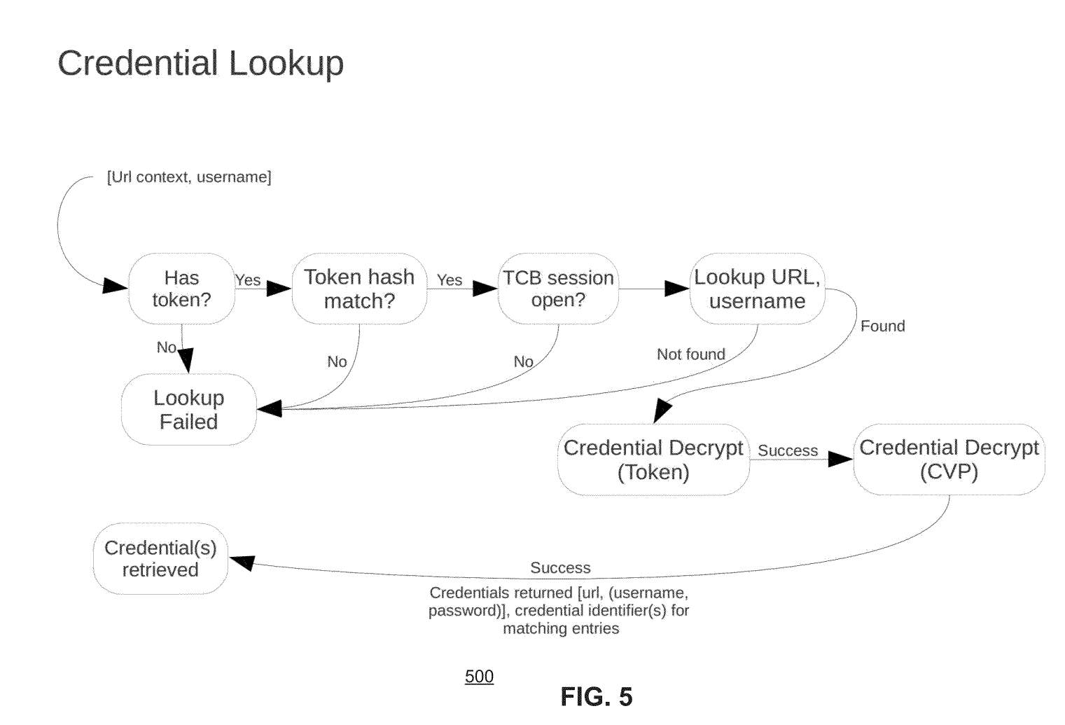

FIG. 5 depicts a flowchart illustrating a process for looking up and retrieving credentials from the credential vault. This process is invoked when the user accesses a website or application, or when the user accesses a website or application and types in a username. The credential application manager application and/or web browser or application prompts the user for the credential vault password and/or the NFC security token. In the embodiment depicted by FIG. 5, the user is only asked for the NFC security token, and then the credential vault manager application verifies the NFC security token by checking for a hash match and determining whether a TCB session is open. If the user fails to provide the NFC security token, the NFC security token hash match fails, or if a TCB session is not open, the look up and retrieval operation fails.

Credentials are stored in the credential vault using the URL (or application identifier) as a key-value map, where the key or multiple keys are used to look up the corresponding credentials. If the user passes the authorization check and a TCB session is open, the credential vault manager application sends a request to the card application (e.g., “Cardlet”) of the TCB to look for credentials matching the URL (or application identifier) that is asking for credentials information.

The user is presented with a prompt to the credential vault's password so it can open a session with the cardlet (as discussed above with respect to opening a session and FIG. 3). One a session is established, if the website asking for credentials is found, a list of possible user accounts is returned. The user can then select which account identity to present to the website.

Upon retrieval of the decrypted credentials for a website or application, the website or application will then have the username and/or password fields automatically filled in. It is further possible to automatically submit the completed username/password form to the website or application to complete the authentication process without the user having to click on a “submit” button. In a further embodiment, submission of credentials to a current website or application requires the user to again present the NFC security token/password, and submission is triggered upon presentation of the NFC security token/password.

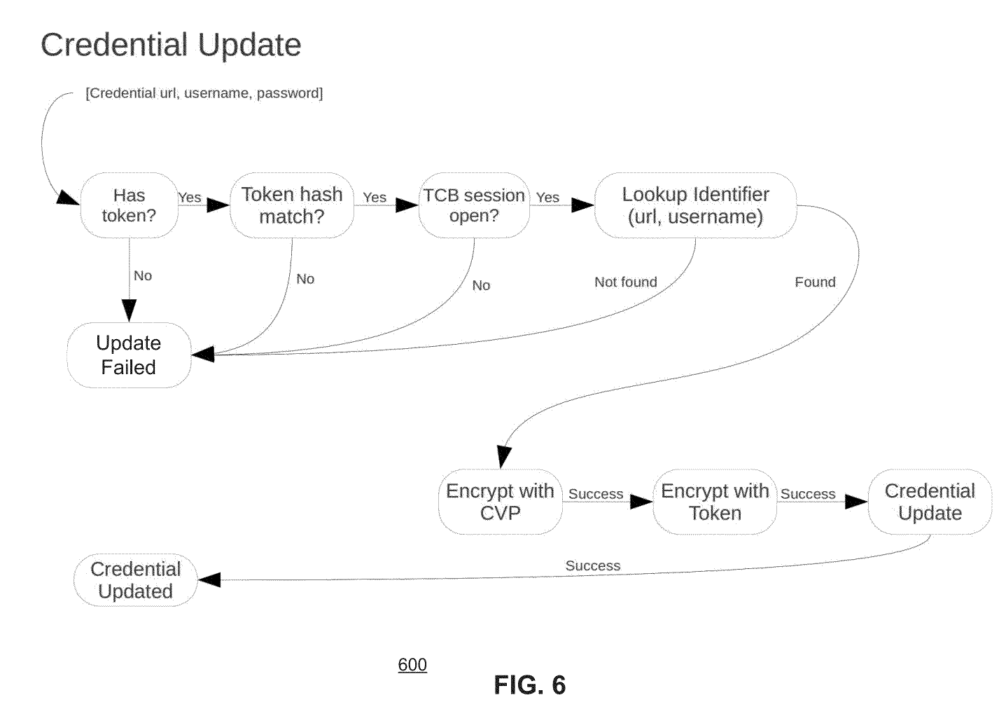

FIG. 6 depicts a flowchart illustrating a process for updating credentials in the credential vault. The user provides a URL (or application identifier) along with a username and password to the credential vault manager. The provision of the URL (or application identifier) and corresponding credentials may be similar to the process for an add operation described above with respect to FIG. 3, where for an update, credentials information is provided that conflicts with pre-existing credentials information stored for that URL (or application identifier) in the credential vault).

The credential application manager application and/or web browser or application prompts the user for the credential vault password and/or the NFC security token. In the embodiment depicted by FIG. 6, the user is only asked for the NFC security token, and then the credential vault manager application verifies the NFC security token by checking for a hash match and determining whether a TCB session is open. If the user fails to provide the NFC security token, the NFC security token hash match fails, or if a TCB session is not open, the update operation fails.

The credential application manager application then sends a request to the card application (e.g., “Cardlet”) to look up the URL (or application identifier) or the URL (or application identifier)-username pair stored in the credential vault. If it is not found, the update operation fails. If it is found, the updated credentials information is encrypted and stored in the credential vault.

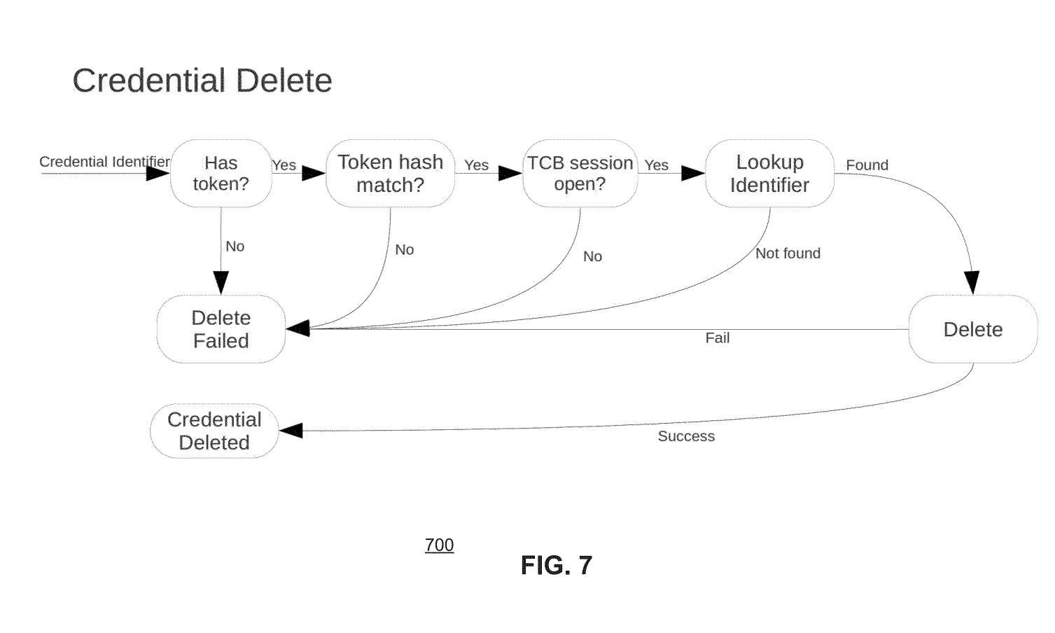

FIG. 7 depicts a flowchart illustrating a process for deleting credentials in the credential vault. The process is similar to the process for updating credentials described in FIG. 6. The user provides a URL (or application identifier) or a URL (or application identifier)-username pair, and, if found stored in the credential vault, the corresponding credentials are deleted (assuming the user passes the initial authorization check).

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” should be interpreted as including any singular entity from the listed elements, e.g., A, any subset from the listed elements, e.g., A and B, or the entire list of elements A, B and C.

1. A method for utilizing a secure credential vault on a mobile computing device, the method comprising:
prompting, by the mobile computing device, a user for a credential vault password and receiving the credential vault password from the user;
prompting, by the mobile computing device, a user for a near-field communication (NFC) security token and receiving the NFC security token from a NFC-enabled device;
verifying, by the mobile computing device, the credential vault password and the received NFC security token; and
opening, by the mobile computing device, a secure session with the secure credential vault in response to successful verification.

2. The method of claim 1, wherein verifying the received NFC security token further comprises:
verifying that a hash of the received NFC security token matches a stored hash value.

3. The method of claim 1, further comprising:
receiving a request to add credentials to the secure credentials vault;
determining that the secure session is open;
encrypting credentials data to be added to the secure credentials vault; and
storing the encrypted credentials data at the secure credentials vault.

4. The method of claim 3, wherein the credentials data is encrypted using the credentials vault password and the NFC security token according to a symmetric encryption algorithm.

5. The method of claim 3, wherein the credentials data is encrypted according to an asymmetric encryption algorithm.

6. The method of claim 1, further comprising:
determining that a timeout condition has been reached based on an amount of elapsed time while the secure session is open; and
closing the secure session.

7. The method of claim 1, wherein the secure credentials vault is stored in a trusted computing base (TCB) and the TCB is part of a subscriber identity module (SIM) card.

8. A non-transitory computer-readable medium, part of a mobile computing device, having processor-executable instructions stored thereon for utilizing a secure credential vault, the processor-executable instructions, when executed by a processor, causing the following steps to be performed:
prompting a user for a credential vault password and receiving the credential vault password from the user;
prompting a user for a near-field communication (NFC) security token and receiving the NFC security token from a NFC-enabled device;
verifying, by the mobile computing device, the credential vault password and the received NFC security token; and
opening, by the mobile computing device, a secure session with the secure credential vault in response to successful verification.

9. The non-transitory computer-readable medium of claim 8, wherein verifying the received NFC security token further comprises:
verifying that a hash of the received NFC security token matches a stored hash value.

10. The non-transitory computer-readable medium of claim 8, wherein the processor-executable instructions, when executed, further cause the following:
receiving a request to add credentials to the secure credentials vault;
determining that the secure session is open;
encrypting credentials data to be added to the secure credentials vault; and
storing the encrypted credentials data at the secure credentials vault.

11. The non-transitory computer-readable medium of claim 10, wherein the credentials data is encrypted using the credentials vault password and the NFC security token according to a symmetric encryption algorithm.

12. The non-transitory computer-readable medium of claim 10, wherein the credentials data is encrypted according to an asymmetric encryption algorithm.

13. The non-transitory computer-readable medium of claim 8, wherein the processor-executable instructions, when executed, further cause the following:
determining that a timeout condition has been reached based on an amount of elapsed time while the secure session is open; and
closing the secure session.

14. The non-transitory computer-readable medium of claim 8, wherein the secure credentials vault is stored in a trusted computing base (TCB) and the TCB is part of a subscriber identity module (SIM) card.

15. A mobile computing device for providing a secure credential vault, the mobile computing device comprising:
a memory, comprising a credential vault manager application stored thereon;
a processor, configured to execute the credential vault manager application;
a secure element connected to the processor via a secure element interface, the secure element comprising the secure credential vault and a card application;
a near-field communication (NFC) reader, configured to communicate with a physical NFC-enabled device; and
an input interface, configured to receive input from a user;
wherein the device is configured to receive a credential vault password from the user via the input interface and to receive an NFC security token via the NFC reader; and
wherein execution of the credential vault manager application includes verifying the received credential vault password and the received NFC security token, and opening a secure session with the credential vault of the secure element in response to successful verification.

16. The mobile computing device of claim 15, wherein verifying the received NFC security token includes verifying that a hash of the received NFC security token matches a stored hash value.

17. The mobile computing device of claim 15, wherein the card application is configured to encrypt credentials data to be added to the credentials vault using the credentials vault password and the NFC security token according to a symmetric encryption algorithm.

18. The mobile computing device of claim 15, wherein the card application is configured to encrypt credentials data to be added to the credentials vault according to an asymmetric encryption algorithm.

19. The mobile computing device of claim 15, wherein execution of the credential vault manager application further includes determining that a timeout condition has been reached based on an amount of elapsed time while the secure session is open and closing the secure session in response thereto.

20. The mobile computing device of claim 15, wherein the secure element is a subscriber identity module (SIM) card.
